(19) United States
(12) Patent Application Publication
(10) Pub. No.: US 2004/0170382 A1
(43) Pub. Date: Sep. 2, 2004

(54) Task-oriented nonlinear hypervideo editing method and apparatus

(75) Inventor: Vladimir Portnykh, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/626,769

(22) Filed: Jul. 25, 2003

(30) Foreign Application Priority Data
Aug. 8, 2002 (KR) 2002-46801

(51) Int. Cl. H04N 5/76; G11B 27/00; G09G 5/00

(52) U.S. Cl. 386/52; 345/723

(57) ABSTRACT

Provided are a task-based hypervideo editing method and an apparatus which overcome problems of related art nonlinear editors, such as Adobe Premier, by providing a descriptor language which describes user's editing commands and suggesting an algorithm corresponding to the descriptor language. In the nonlinear video editing method, first, available user actions are initialized. Next, a user action is selected from the initialized available user actions. Thereafter, input resources used to perform the selected user action are selected. Then, the selected user action is performed, and the results of the user action are examined. Finally, finishing the user action is confirmed, and the results of the user action are rendered. Accordingly, results of previous steps in an editing process can be used as real source files and computer resources are saved, thereby shortening the time required and increasing the productivity of editing.

### BACKGROUND OF THE INVENTION

This application claims priority from Korean Patent Application No. 2002-46801, filed on Aug. 8, 2002, in the Korean Intellectual Property Office, the disclosure of which is incorporated herein in its entirety by reference.

1. Field of the Invention

The present invention relates to a nonlinear hypervideo editing method, and more particularly, to a hypervideo editing method and an apparatus that overcome the related art problems of nonlinear editors, such as Adobe Premier, by providing a descriptor language that describes user's editing commands and suggests an algorithm corresponding to the descriptor language.

2. Description of the Related Art

Examples of related art home or professional media editors include timeline editors or storyboard editors. Timeline editors can express an image as a set of rows of screens according to time. However, since resources are configured in a form such that various video clips, sound tracks, and effects are stacked, the timeline editor is not suitable to edit videos according to the flow of time. For example, but not by way of limitation, the time line editor requires a great number of windows to edit long movies.

Storyboard editors arrange media resources in units of a series of blocks from left to right. Overlap between clips is managed by placing a transition called a T-block into the space between the clips, and then tuning the properties of a transition using an additional dialog box.

Storyboard editors as described above allow users to deal with still images and organize a slide show easily. However, the related art storyboard editors have functional limitations, because storyboard editing lacks a concept of time.

Korean Patent Publication No. 1999-55423 discloses a method of processing videos using a project table and managing data on changeover effect filters and special visual effect filters, and a method of producing new digital videos without requiring decompression. The concept of a project table is used, which includes clip IDs, storages, track starts, track ends, source starts, source ends, types, track numbers, and apply clips.

However, the foregoing related art has various problems and disadvantages. For example, but not by way of limitation, the invention provided by the above Korean patent has no concept of user's editing commands and does not disclose a concrete descriptor language of editing commands.

U.S. Pat. No. 5,539,527 discloses a nonlinear video editing system, which includes a randomly accessible image data storage unit, an FIFO, a video effect unit, and a desired shot storage unit. However, the aforementioned nonlinear video editing system is different from a nonlinear video editing method according to the present invention, as described in greater detail below.

FIG. 1 is a table showing the concept of the related art timeline editing method. In the related art timeline editing method, a video is expressed in a set of rows of video clips according to time, and the set of rows stacks various video clips, sound tracks, and effects in sequence.

To begin editing, an icon representing a video clip is selected and dragged into a timeline interface. The video clip is represented as a bar, and the length of the bar indicates the actual duration of the clip in accordance to the time ruler of FIG. 1.

A desired editing operation is performed with the bar, and at the same time, different editing operations can be performed by controlling the time. Using a mouse, a user can point an exact time to start displaying. Using additional commands, a user can split a movie into separate pieces, delete some of the pieces and re-arrange others, and define a transition, while easily controlling the time of transition.

The implementation of the timeline method usually requires a rendering operation before previewing. Since there is a close connection with time, the timeline method is unsuitable for dealing with still images and video clips simultaneously.

The timeline method is also unsuitable for long video clips, because a long time for scrolling is needed. Accordingly, several screens are required. For example, but not by way of limitation, in the case of a 90-minute movie, more than 30 screens are required.

A change in time scale can take place. However, such a change prevents the user from having the ability to precisely edit in a specific place. To perform precise editing, additional windows are needed. The timeline method is oriented to work with several consecutive clips. In other words, if ordered clips are placed into different tracks, it is possible to define a transition and control its duration. It is not required for different clips to be placed into the same line. However, if the different clips are not placed in the same line, the definition of the transition becomes more complicated.

Thus, the related art timeline method is suitable for editing short video clips and an exact example of a linear editing approach and its limitations. The linear editing approach is not obligatory at present, but influences present nonlinear editing systems. In other words, in the related art timeline method, dealing with still images and organizing them into a sequence to display in a proper order is difficult.

FIG. 2 illustrates the concept of a related art storyboard editing method. Starting editing in the related art storyboard editing method is the same as the related art timeline method. More specifically, first, a user selects a thumbnail and drags it into a storyboard interface. Thereafter, the user makes a series of blocks of media resources and arranges the blocks so that they move from left to right. The overlap between clips is managed by placing a transition referred to as a T-block into the space between the clips, and then tuning the properties thereof using an additional dialog box.

Editors adopting the related art storyboard editing method allow users to deal with still images and organize a slide show easily. The benefit of the storyboard editing method is its lucidity. However, editing possibilities are limited because there is no time concept.

In the related art, some editing tasks can be effected efficiently. For example, if two video clips are to be merged, it is necessary to put them into consecutive cells and select them to execute the merge command.

However, there exist some problems in a related art operation of splitting a merged video clip into two independent video clips. In fact, splitting cannot be performed in the related art storyboard interface because of the absence of time concept. Generally, any operations related to time require additional windows, and this requirement makes the storyboard editing method more complex than the related art timeline editing method.

The related art storyboard method may not be a linear approach, but it still has influence on the linear approach. For example, the transition is defined as an indication to segue from one video clip to another. Accordingly, only two video clips are involved. This is a rule in linear editing methods. But, at present, simultaneous processing of three video sources is required to obtain good performance. Thus, the related art fails to meet the performance requirement for video editing.

### SUMMARY OF THE INVENTION

The present invention provides a task-oriented nonlinear hypervideo editing method and apparatus for efficiently performing an editing process by providing a novel descriptor language for user's editing actions, dynamically controlling the editing process, and expressing the results of the edition in the XTL.

a nonlinear video editing method is provided that includes expressing a user action to be selected and performed as a template that includes a component, and described in an extended Markup Language (XML), and performing the user action and rendering a result of the user action.

Additionally, a nonlinear video editing method is provided that includes initializing a plurality of available user actions, selecting one of the plurality of initialized available user actions, and selecting input resources that perform the selected available user action. Further, the method includes performing the selected available user action and examining results of the performed available user action, and confirming finishing of the available user action and rendering the results of the finished user action.

Also, a nonlinear video editing apparatus is provided that includes a user action initialization unit that initializes available user actions, a user action input unit that receives a user action selected by a user from the initialized available user actions, and a resource input unit that receives input resources used to perform the selected user action. The apparatus also includes a user action performing unit that performs the selected user action based on the respective outputs of the user action initialization unit, the user action input unit and the resource input unit, a result examining unit that examines results of the performed selected user action, and a rendering unit that confirms finishing of the selected user action and renders the results of editing.

A graphic user interfacing method in a nonlinear video editor is also provided, including presenting available user actions to a user and providing a display for receiving a user action selected by the user, providing a source file display for presenting and displaying a source file used to perform the selected user action, and providing a result display for displaying results of the selected user action performed using the source file selected by the user.

Additionally, a computer readable medium configured to implement instructions for nonlinear video editing method is provided.

### BRIEF DESCRIPTION OF THE DRAWINGS

The above and other features and advantages of the present invention will become more apparent by describing in detail exemplary embodiments thereof with reference to the attached drawings in which:

FIG. 1 is a table showing the concept of a related art timeline editing method;

FIG. 2 illustrates the concept of a related art storyboard editing method;

FIG. 3 is a flowchart for illustrating a video editing method according to an exemplary, non-limiting embodiment of the present invention;

FIG. 4 shows a template that describes user's actions according to an exemplary, non-limiting embodiment of the present invention;

FIG. 5 is a table showing the properties of a template TRANSFORM, the properties of a template RESOURCE, and the properties of a template VUNION according to an exemplary, non-limiting embodiment of the present invention;

FIG. 6 shows a splitting action template according to an exemplary, non-limiting embodiment of the present invention;

FIG. 7 shows a transition action template according to an exemplary, non-limiting embodiment of the present invention;

FIG. 8 shows a merging action template according to an exemplary, non-limiting embodiment of the present invention;

FIG. 9 shows an inserting action template according to an exemplary, non-limiting embodiment of the present invention;

FIG. 10 is a table describing basic user actions according to an exemplary, non-limiting embodiment of the present invention;

FIG. 11 shows a screen called a decision center according to an exemplary, non-limiting embodiment of the present invention;

FIG. 12 shows a screen that appears when a splitting action is selected according to an exemplary, non-limiting embodiment of the present invention;

FIG. 13 shows an example in which user actions to perform a splitting operation are described according to an exemplary, non-limiting embodiment of the present invention;

FIG. 14 shows an example in which user actions to perform an inserting operation are described according to an exemplary, non-limiting embodiment of the present invention;

FIG. 15 is a table showing the attributes of a language according to an exemplary, non-limiting embodiment of the present invention;

FIG. 16 illustrates an insertion of BBB.AVI into AAA.AVI according to an exemplary, non-limiting embodiment of the present invention;

FIG. 17 shows a result of an optimization of the contents of FIG. 16 according to an exemplary, non-limiting embodiment of the present invention;

FIG. 18 is a block diagram of a nonlinear video editing apparatus according to an exemplary, non-limiting embodiment of the present invention;

FIG. 19 is a flowchart for illustrating an algorithm for verifying edition results according to an exemplary, non-limiting embodiment of the present invention;

FIG. 20 is a block diagram of an architecture of a virtual union (vunion) according to an exemplary, non-limiting embodiment of the present invention; and

FIG. 21 is a flowchart for illustrating an algorithm for optimizing edition results according to an exemplary, non-limiting embodiment of the present invention.

### DETAILED DESCRIPTION OF THE INVENTION

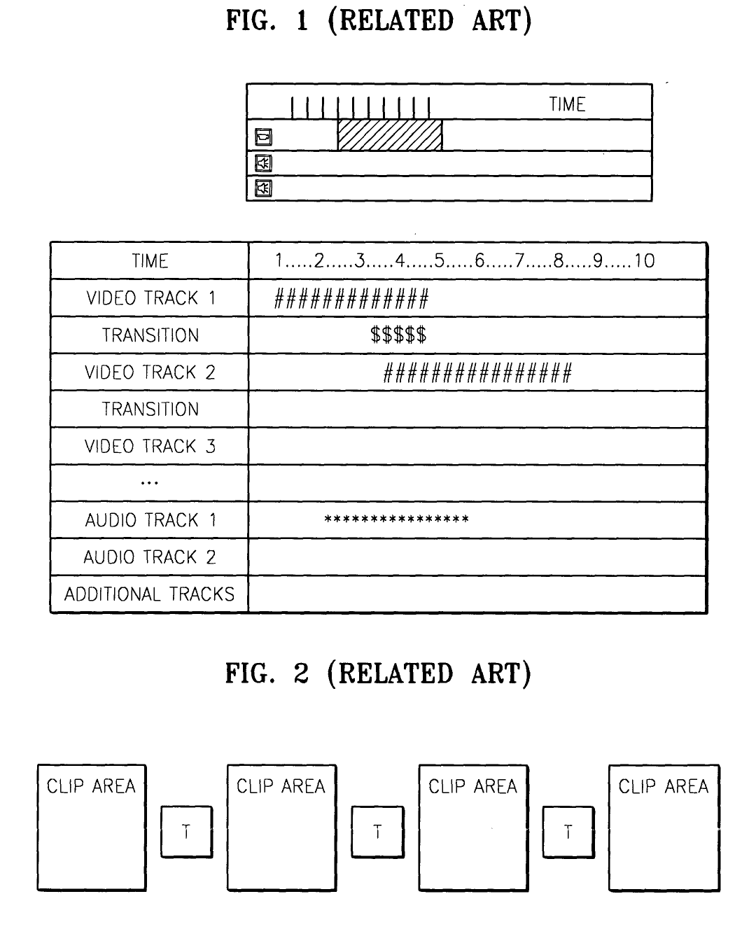

The related art timeline editing method and the related art storyboard editing method have been described above with reference to FIGS. 1 and 2. These two related art editing methods have many variations. However, it can be observed that no new ideas are added, and the variations stick to the above-described principle. Existing software packages attempt to implement these modifications in the best way by paying special attention to the technical aspects of video transcoding and by slightly improving the two editing methods described above. However, the related art fails to overcome the aforementioned problems related to performance requirements.

The present invention proposes a novel descriptor language of user actions. The novel descriptor language is called an AV Station Editing Language (AVSEL). The AVSEL is based on eXtended Markup Language (XML), so the term “hypervideo” is used. The present invention also provides a special algorithm to dynamically control an editing process and express editing results in terms of an XML transformation language (XTL). Furthermore, the present invention provides a language analyzer and a grammar translator for translating from AVSEL to XTL or vice versa.

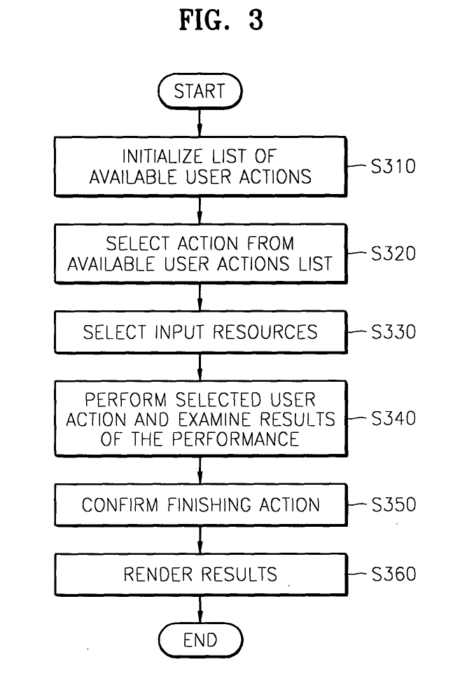

FIG. 3 is a flowchart for illustrating a video editing method according to an exemplary, non-limiting embodiment of the present invention, and is based on a novel idea in which a video editing process is considered a decision-making process. Accordingly, attention is paid on the logic of editing, rather than other factors (e.g., timing).

The video editing method of FIG. 3 has various special characteristics. First, no rendering is performed during editing. Second, the results of previous operations in FIG. 3 can be used as real source files during editing. The results are virtual, logical results, but appear as real media sources for users. Thus, computer storage resources are saved, and the productivity of editing is noticeably increased by shortening required time. Third, user's actions can be put into a decision list. An editing system knows the type of rendering operation to be executed in the future after finishing editing. Fourth, a rendering process is algorithmically optimized using a method. Fifth, the results of editing can be expressed in three different forms: a list of performed actions, logical results of actions performed for rendering, and real media files. Sixth, conversion between logical results in an absolute form and logical results in related forms is implemented. Seventh, the openness is not only for new video/audio transforms, but also for new user actions.

The steps of the method illustrated in Figure are described in greater detail below. A list of available user actions is initialized in step S310. An action template language, i.e., AVSEL, is described here.

Next, an editing process written as a sequence of user actions expressed in the user action template language is performed. Every user action consists of several steps. In step S320 an action is selected from the available user actions list, and in step S330 of input resources are selected before performing operations to implement the selected action described in a language described at a later time. In step S340 the selected action and examining action results are performed simultaneously.

In step S350, after examination of the action results, a finishing action is confirmed. In step S360, rendering is performed.

For the AVSEL for describing user actions, different categories of users have different aims of editing and pay attention to different aspects of an editing process. Step S310 is actually a pre-editing process, which includes identifying user needs and configuring a method in accordance with the needs.

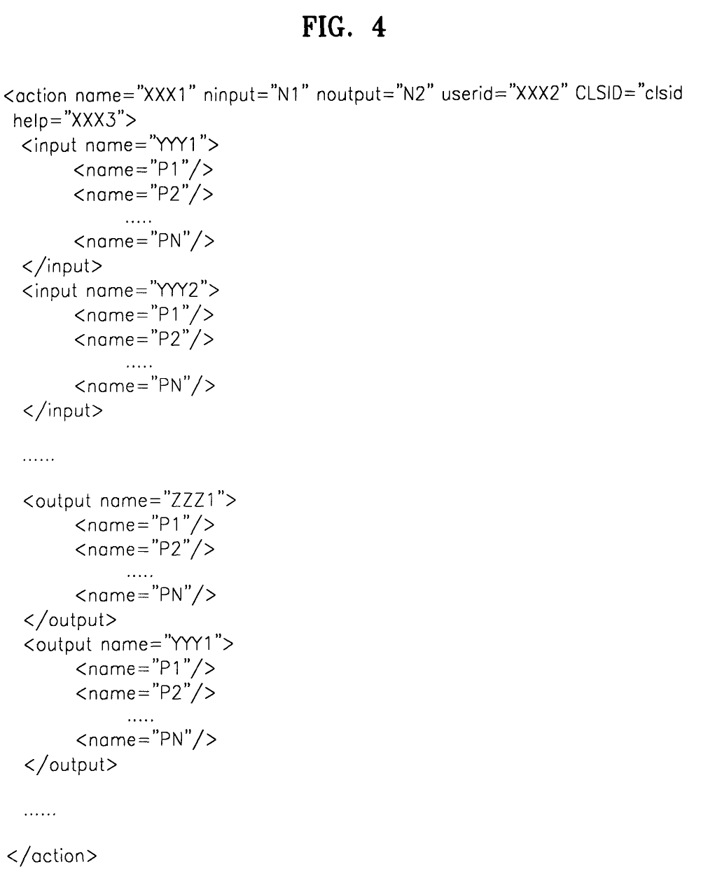

FIG. 4 shows a template that describes user actions. In FIG. 4, XXX1 denotes the name of an action, N1 denotes the number of input parameters, N2 denotes the number of output parameters, userid indicates the level of access to the action, CLSID denotes a clsid of the action, and helps to indicate a small tip about the action. Similarly, YYY1 denotes the name of an input resource, P1 through PN denote the names of resource characteristics, and ZZZ1 denotes the name of an output result. Here, action, input, output, help, name, userid, ninput, and noutput are reserved words.

There are three pre-defined names of resources: TRANSFORM, RESOURCE, and VUNION. TRANSFORM means transition or effects that can be applied to describe a certain behavior of resources. RESOURCE means a physically existing real resource, such as movie clips. VUNION means a virtual union of real resources and transforms.

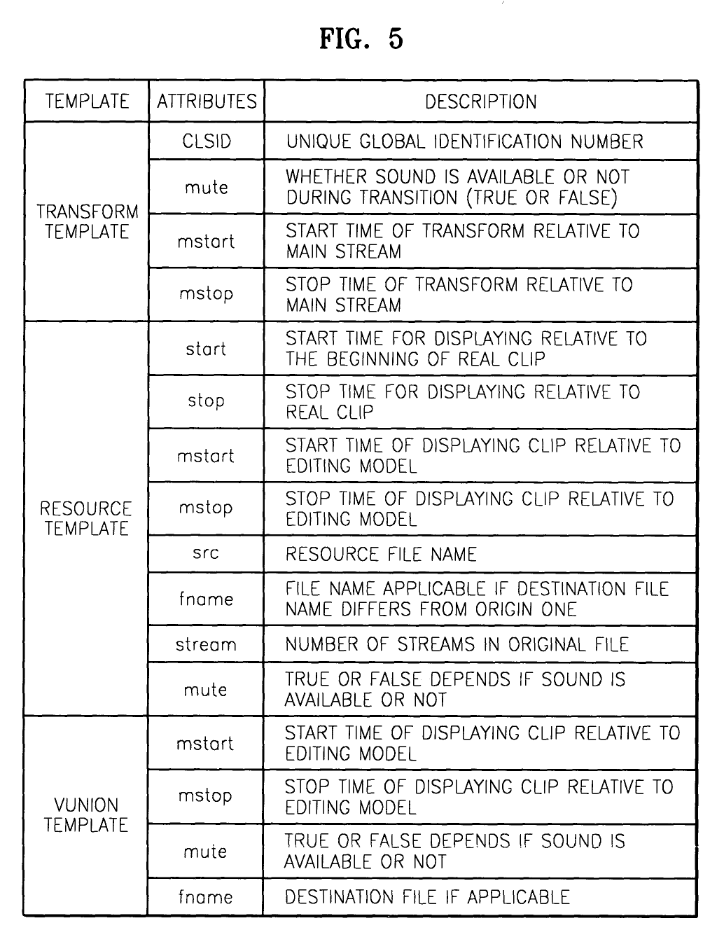

FIG. 5 is a table showing the properties of TRANSFORM, the attributes of RESOURCE, and the attributes of VUNION. Hereinafter, how the above-described template is used will be described by example.

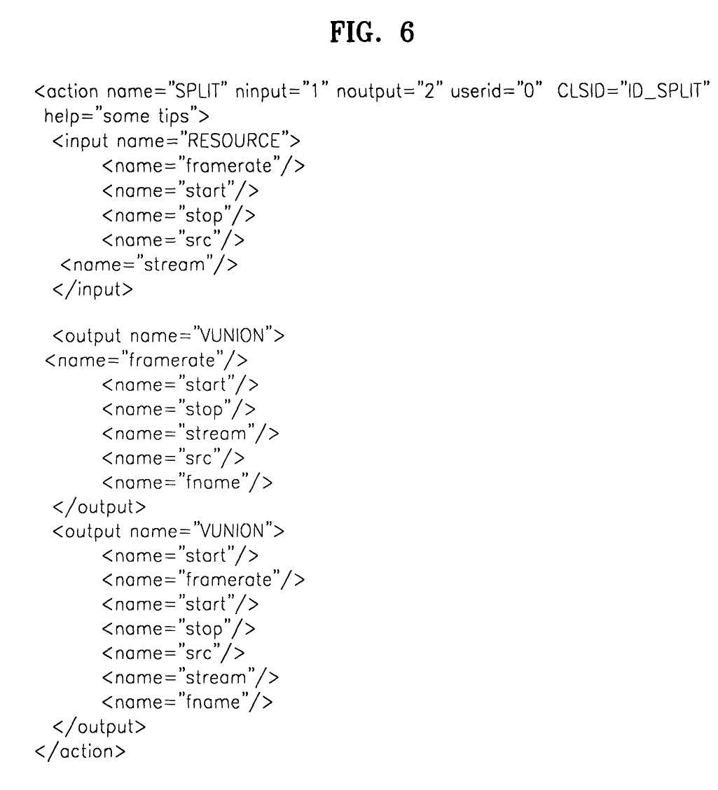

FIG. 6 shows a SPLIT action template according to an exemplary, non-limiting embodiment of the present invention. A SPLIT operation has one input parameter and two output parameters. Input and output parameters are based on the resources. In a case where an input parameter is a real file, output parameters are separated results that are accessible independently. Accordingly, an attribute “fname” is applicable.

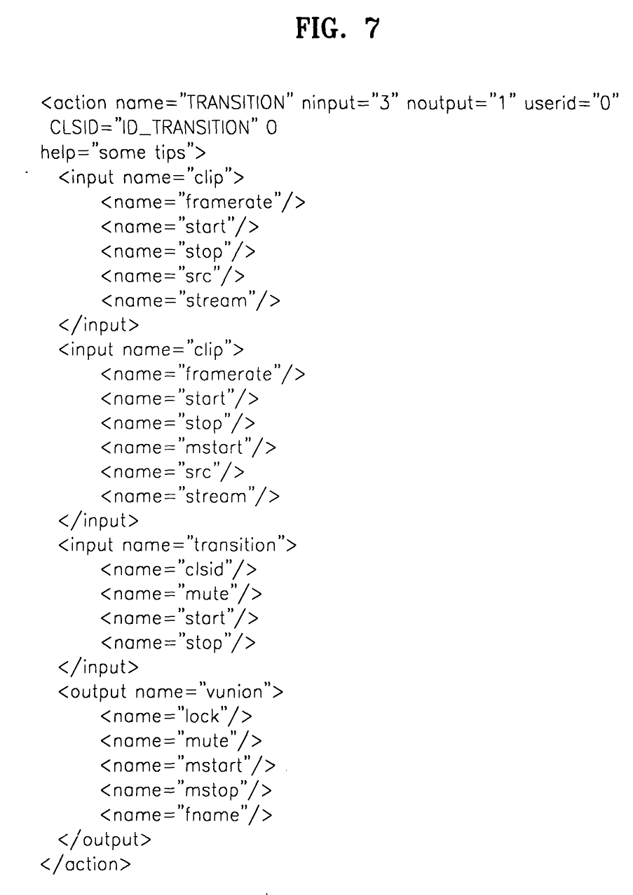

FIG. 7 shows a TRANSITION action template. A TRANSITION between two video clips has three input parameters, namely, two real resources and a transition description. An output parameter is a union or a combination of the input parameters. If a result of an operation is accessible as a whole union, “fname” must indicate this case. “mstart” is 0 as a default, and “mstop” can be a difference between the length of a transition and the sum of the lengths of the first and second video clips.

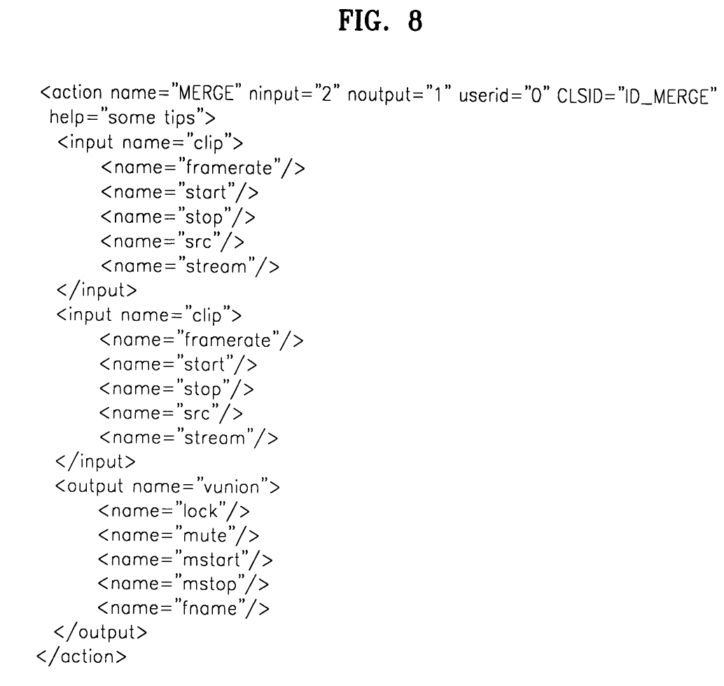

FIG. 8 shows a merging action template according to an exemplary, non-limiting embodiment of the present invention. A merging operation means concatenating two resources one by one to make a new resource, so “fname” can be used as the result. “mstart” is 0, and “mstop” is equal to the sum of the lengths of the first and second video clips.

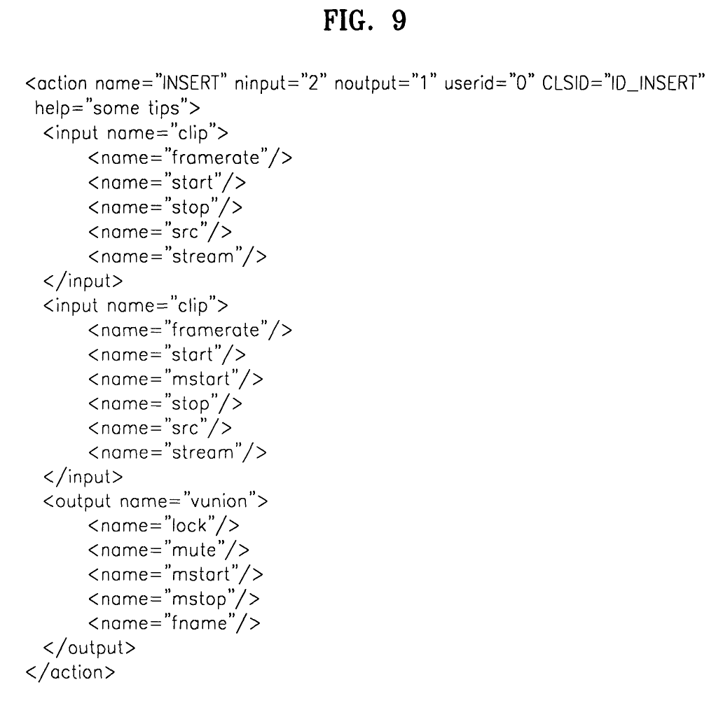

FIG. 9 shows an inserting action template according to an exemplary, non-limiting embodiment of the present invention. A real video clip, which is a second resource, has an attribute “mstart” which indicates the time relative to the insertion point of a first video clip. “mstart” is 0 as a default, “mstop” is equal to the sum of the duration lengths of the first and second video clips, and “mlength” is the sum of the mstop of the first video clip and the mstop of the second video clip.

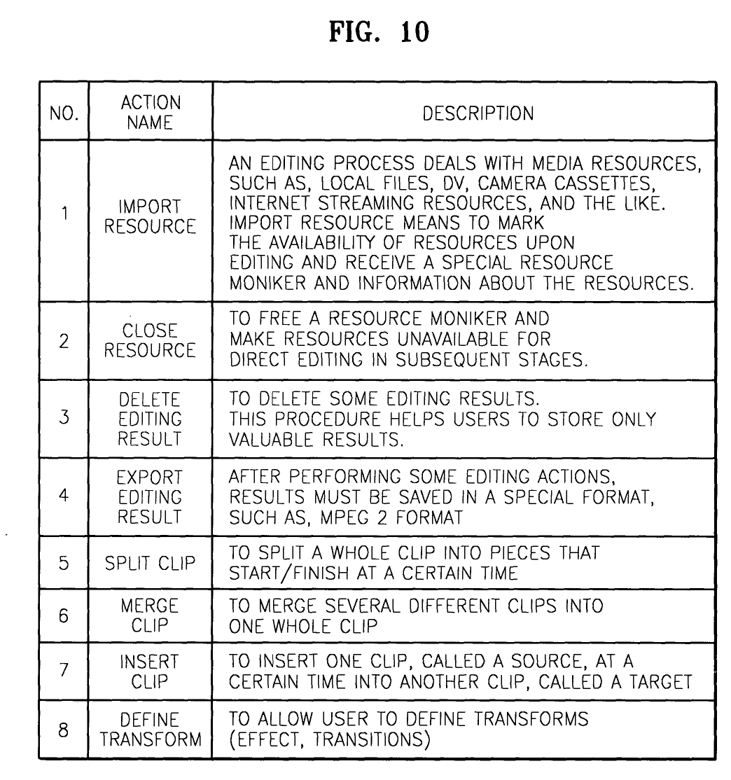

FIG. 10 is a table describing basic editing actions. Further user actions can be described. A list of available actions is contained in a .ini file of an editor. The user action template language provided by the present invention is totally different from an XTL in terms of both idea and usage. The latter language expresses an editing process in terms of results using an approach for rendering process optimization. Accordingly, the latter language is related to the language provided by the present invention, but it is not the same. The language provided by the present invention describes user actions, while the XTL describes the results of an editing process.

Upon an initialization of user actions, the availability of every user action is re-checked, and a main window is configured.

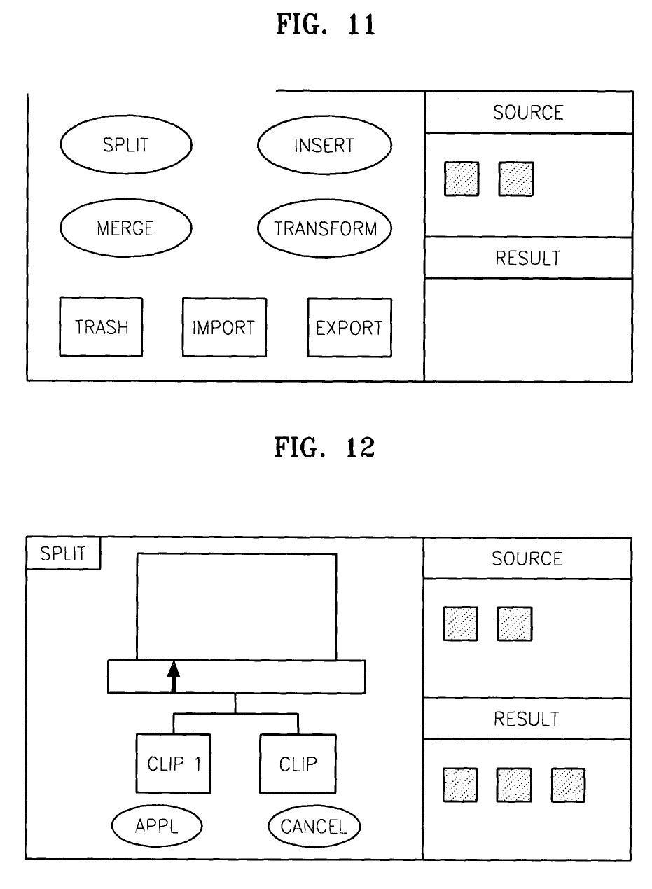

FIG. 11 shows a decision center screen according to an exemplary, non-limiting embodiment of the present invention. An editing process starts from displaying a main window known as the decision center. In the first step, a desired action is selected. Some types of operation can be performed on the screen of FIG. 11. For example, but not by way of limitation, the deletion of results can be performed by dragging a button “RESULT” onto a button “TRASH”. Some actions need an additional step. For example, but not by way of limitation, after a splitting action “SPLIT” is selected, another window appears as shown in FIG. 12.

FIG. 12 shows the screen (i.e., display) that appears when the splitting action is selected. A media source is activated by dragging a source or result icon to be split into a main area, or double clicking on the source icon to be split. A split task is performed by controlling a scrollbar under the screen indicating the split position and pressing a button ‘APPL’ to apply the action. Split results are displayed on the result window. However, results are not available as real files for users at this time, and a rendering is performed after finishing editing, since the system knows the suitable form of rendering operation to be executed. Thus, results are logical results, but they appear as real media resources for users.

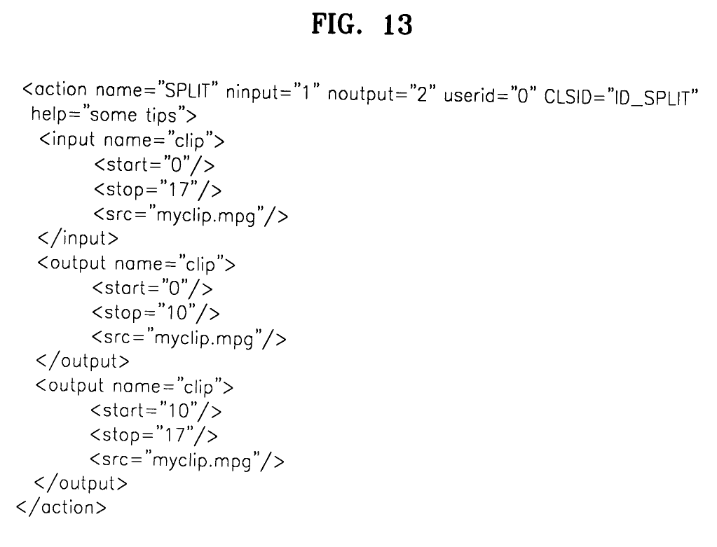

FIG. 13 shows an example in which user actions to perform a splitting operation are described. A decision list denotes a list of user actions performed. For the splitting operation, the next information is put into the decision list. In FIG. 13, some parameters are omitted and treated as default behaviors. The original video clip “myclip.mpg” is split into two clips: the first clip having a duration of 10 starting from the very beginning; and the second clip having a duration of 7 starting from 10.

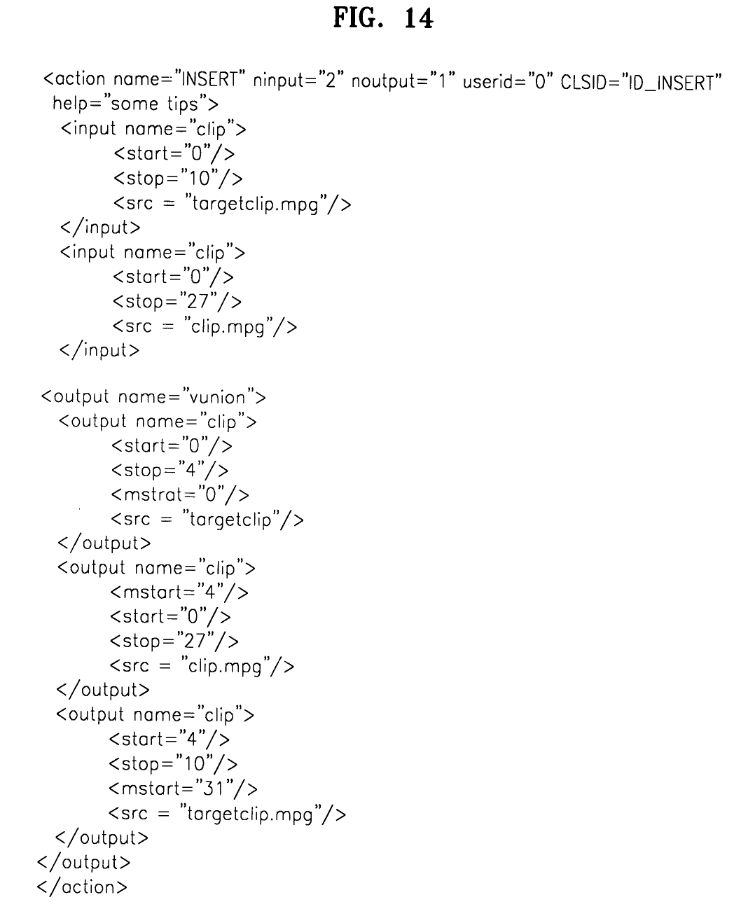

FIG. 14 shows an example in which user actions perform an inserting operation. Because a vunion is used, the result is treated as one video clip but has a complex structure. “mstart” denotes the time in a union proposed by the present invention. A union is defined as a small timeline. The editing method according to the present invention helps users to deal with time. The algorithm for calculating “mstart” depends on the type of actions, and must be provided by an action and the process of implementing the action. However, there is also a general algorithm for calculating “mstart”. According to the general algorithm, “mstart” for the first video clip in the union is 0, “mstart” for the second video clip in the union is equal to the duration of the first video clip, and “mstart” for every next video clip increases by the duration of the previous video clip.

After confirmation of an action finishing, a user can select another action or repeat the same action. Every action is added to an action list. In the editing method according to the present invention, action results are available immediately without any time delay, but they are virtual. User actions and their results are expressed in the language provided by the present invention, and they will be exported to become a real result in response to a special command.

Users can create a decision list manually because the decision list is an open source and accessible in text editors. A language description is available, and another tool can be used to automatically produce the decision list.

If a user wants real results, the user has just to press a button EXPORT after every operation. Accordingly, real sources are generated, but the generation requires extra time and computer resources. As a default after finishing editing, the list of user actions is available.

After the finishing of an action is confirmed, rendering is performed. Users can achieve certain results in a way that is optimal for users, although not optimal for rendering. Hence, there is a need to present obtained results in another way. There are 3 principally different formats available: a user decision list (transcription of user actions), a result summary, and a real media file(s). The user decision list has already been described above, and the real media file(s) is the same as a related art media file.

The result summary is based on the XML and deals with sources as links. The main difference from the user decision list is that information on how the results are obtained is ignored, and attention is concentrated on the results. In this format, all user actions are summarized, and every virtual result is substituted by a description on how it was obtained. Contents are sorted by time according to a value “mstart”, and extra nesting is eliminated. This format is almost ready for rendering and is convertible into the XTL. According to this converted format, user actions are recovered. Results of editing are results of user actions, so the language proposed by the present invention deals with TRANSFORM, RESOURCE, and VUNION. These attributes are:

TRANSFORM={CLSID, mute, mstart, mstop}

RESOURCE={start, stop, mstart, mstop, src, fiame, stream, mute}

VUNION={mstart, mstop, mute, fname}

These are basic components of user action descriptions. Because the property of a transform can vary, only a basic structure can be fixed.

The fundamental semantic of the language provided by the present invention is substantially equal to the semantic of the XTL, so it will not be described in detail. Compared with XTL from Microsoft, there are critical improvements, some technical and others novel. This technical idea is defined in the attributes of the language provided by the present invention.

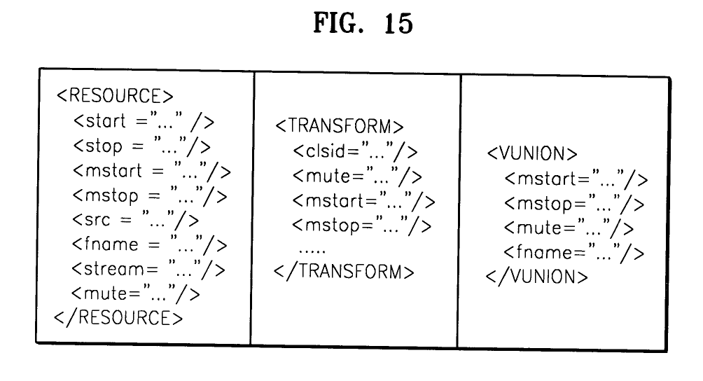

FIG. 15 is a table showing the attributes of the language according to an exemplary, non-limiting embodiment of the present invention. Instead of using “41 ”, “′” is used, or symbols cannot be used. RESOURCE is similar to CLIP in the XTL, but some extra attributes have been removed from the RESOURCE. TRANSFORM is a combination of TRANSITION and EFFECTS in the XTL, the combination of which was made to simplify an editing process. VUNION actually brings about the present invention's distinctiveness. VUNION has attributes “mstop” and “mstart”. The related art technologies lack these attributes, which are critical to optimize the rendering process.

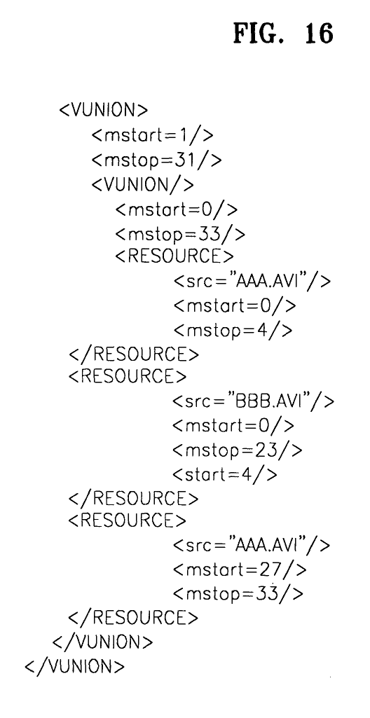

If a simple scenario is taken as an example, there are two files AAA.AVI and BBB.AVI, and their durations are 10 and 23, respectively. BBB.AVI is inserted into AAA.AVI starting from 4. Then, the first one second is cut from the beginning of AAA.AVI and rendering is performed. The last two seconds of AAA.AVI are cut and then rendering is performed. This scenario is expressed in FIG. 16, and discussed below.

FIG. 16 illustrates an insertion of BBB.AVI into AAA.AVI. Every nested VUNION must be rendered before a parent VUNION, because the nested VUNION provides resources, and the hierarchy of a union optimizes a rendering process.

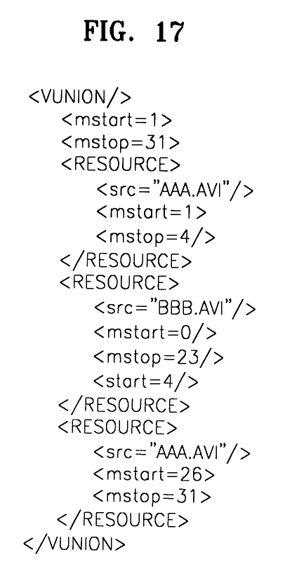

FIG. 17 shows a result of an optimization of the contents of FIG. 16. The effect of optimization is expressed in terms of time required for optimization if it is done in real time. A non-optimized (i.e., related art) result is rendered (31−1)+(33−0)=63, and an optimized result takes (31−1)=30. Hence, the optimization in the language provided by the present invention is two times more effective than an existing technology.

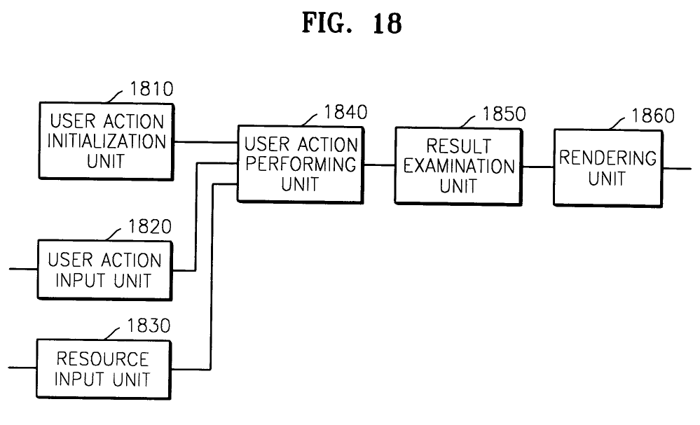

FIG. 18 is a block diagram of a nonlinear video editing apparatus according to an exemplary, non-limiting embodiment of the present invention. The nonlinear video editing apparatus includes a user action initialization unit 1810, a user action input unit 1820, a resource input unit 1830, a user action performing unit 1840, a result examination unit 1850, and a rendering unit 1860.

The user action initialization unit 1810 initializes available user actions. The user action input unit 1820 receives an action selected by a user from the initialized available user actions. The resource input unit 1830 receives input resources used to perform the selected user action. The user action performing unit 1840 performs the selected user action based on the outputs of the user action initialization unit 1810, the user action input unit 1820, and the user action performing unit 1840. While the selected user action is being performed, the result examination unit 1850 examines results. The rendering unit 1860 confirms finishing the action and renders results.

Each of the user actions includes information on the name of the action to be performed, the number of input parameters used by the action, the number of output parameters output as the results of the action, and the level of access to the action to be performed.

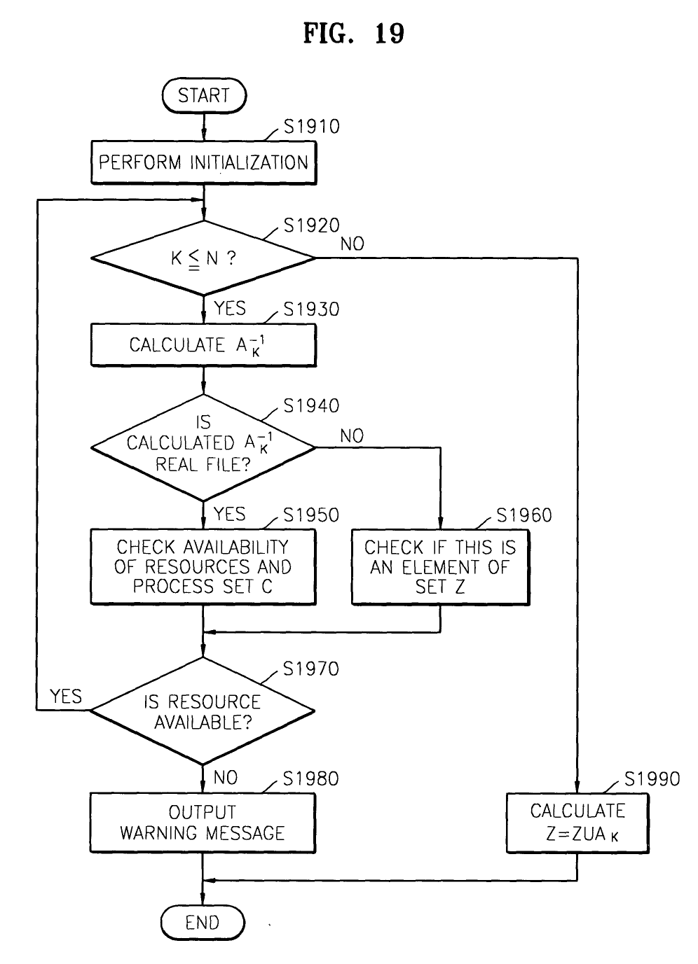

FIG. 19 is a flowchart for illustrating an algorithm for verifying the results of editing. Every program language consists of both syntax and semantics. XML, which is a currently used markup language, also has these characteristics, and a compiler checks the consistency of the meaning of input information. The novel language provided by the present invention also has these characteristics and has additional unique properties.

User actions can be randomly accessed, and are completed by random access results. The verification algorithm of FIG. 19 is an algorithm for verifying the user actions.

Before describing FIG. 19, some terms are defined. C denotes a resource file and is expressed as C={cj}j. Every user action is treated as a function and defined as in Equation 1:

A₁₁, A₁₂, . . . , Aᵢⱼ, . . . , Aₙₘ: Cⁿ→C^{m} (1)

wherein Cⁿ={(c¹, c², . . . , c^{j}, . . . , cⁿ)}, c^{j} ε C, j=1, . . . , n, C^{m}={(c¹, c², . . . , cⁱ, . . . ,c^{m})}, c^{j} ε C, and j=1, . . . ,m.

Z={A₁₁, A₁₁, A₁₁, A₁₁} is defined as a collection of user actions. Aₖ⁻¹ is an inversed function and defined as in Equation 2:

Aₖ⁻¹ε(U,Aj)UC,I=1 . . . k−1 (2)

In the verification process, first, initialization is performed in step S1910. In the initialization step, Z is set to be { }, N, the number of user actions, is received, and K is set to be 1. In step S1920, it is determined whether K≦N.

In step S1930, A_{K}⁻¹ is calculated when step S1920 determines that K≦N. In step S1940, it is checked if the calculated is a real file.

If the calculated A_{K}⁻¹ is a real file, the availability of a resource is checked, and a resource file C is processed in step S1950. On the other hand, if the calculated A_{K}⁻¹ is not a real file, it is checked if the calculated A_{K}⁻¹ is an element of Z, in step S1960.

In step S1970, it is checked if a resource is available. If the resource is available, the method goes back to step S1920. If the resource is not available, a warning message is output, in step S1980. This process is performed until K is equal to N. If K is equal to N, Z=Z∪A_{K} is calculated in step S11990.

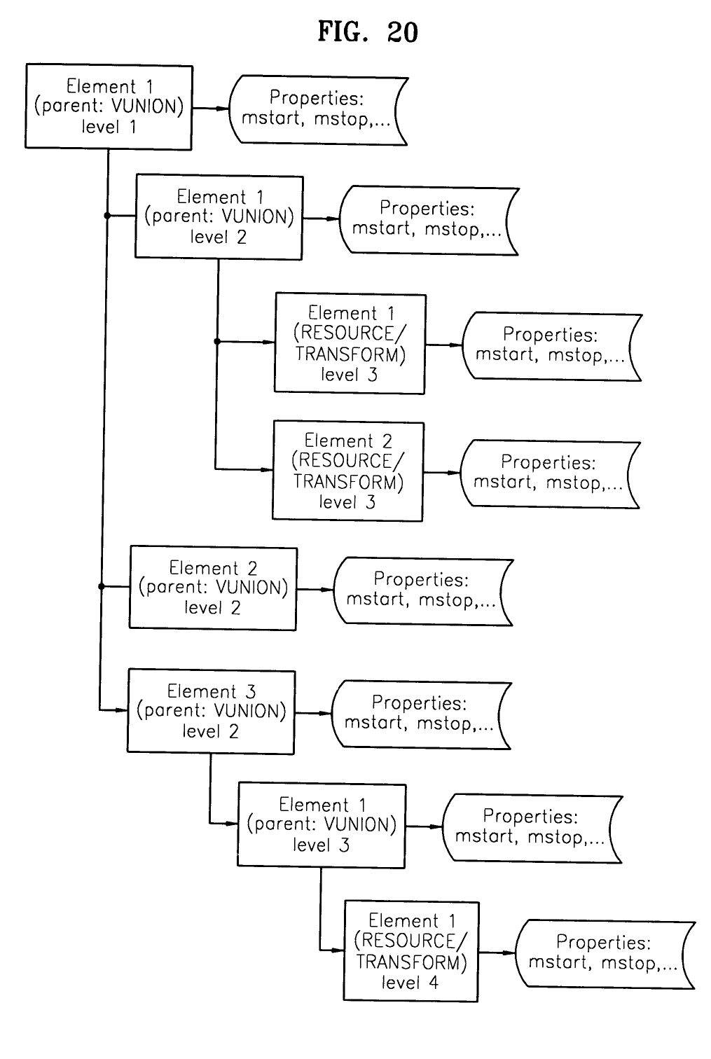

FIG. 20 is a block diagram of an architecture of a virtual union (vunion) proposed in the present invention. As shown in FIG. 20, a vunion is hierarchically configured and has properties, such as, “mstart”, “mstop”, etc.

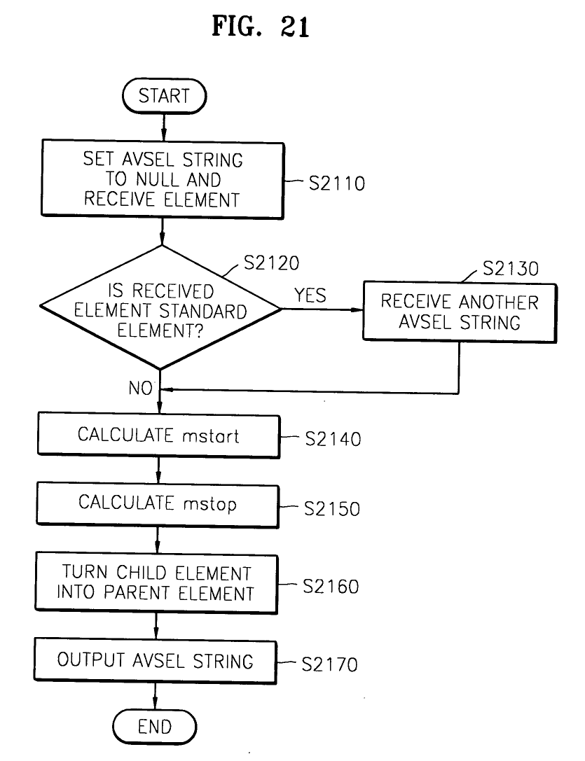

FIG. 21 is a flowchart for illustrating an algorithm for optimizing the results of editing. Rendering is the most important part in an editing process, because it requires a great amount of time. Hence, optimization of the rendering process is significantly important. The time required to perform rendering can be reduced using well-known methods, among which there is a method of improving an encoding technique. This method does not greatly reduce the rendering time. However, the optimization method according to the present invention excels in reducing the rendering time.

In the optimization method, first, an AVSEL string is set to null, and a first element is received in step S2110. In step S2120, it is determined whether the received element is a standard element. In step S2130, another AVSEL string is received if it is determined that the received element is a standard element.

In step S2140, “mstart” is calculated if it is determined that the received element is not a standard element. “mstart” is calculated by setting K1opt to be “start”, moving to the first nested element, and performing the while sentence:

```
While (K1opt > mstop − mstart)
    {K1opt = K1opt − (mstop − mstart)
      Delete current element
      ove to the first nested element
    }
```

After escaping from the while loop, “mstart” and “mstop” of every parent element are adjusted to those of every nested element. In step S2150, “mstop” is calculated by setting K2opt to be “mstop”, moving to the last nested element, and performing the while sentence:

```
While (K2opt < mstart)
    {
        Delete current element
        Move to the last nested element
    }
```

Thereafter, K2opt is stored in “mstop”.

After the calculation of “mstart” and “mstop”, a child element is turned into a parent element, in step S2160. In step S2170, the AVSEL string is output.

This algorithm is applied to every element to obtain an AVSEL string. In other words, the next element is received and undergoes the above-described procedure.

The embodiments of the present invention can be written as computer programs and can be implemented in general-use digital computers that execute the programs using a computer readable recording medium. Examples of computer readable recording media include magnetic storage media (e.g., ROM, floppy disks, hard disks, etc.), optical recording media (e.g., CD-ROMs, or DVDs), and a storage medium such as a carrier wave (e.g., transmission through the Internet).

As described above, the present invention provides a novel descriptor language of user actions and provides a special algorithm for dynamically controlling an editing process and expressing editing results in the XTL. Accordingly, results of the previous steps in an editing process can be used as real source files and computer resources are saved, thereby shortening required time and increasing the productivity of editing.

In a video editing method according to the present invention, a user has to identify a problem first, clearly understand input information, and accomplish a task according to a special procedure to obtain certain results. In this method, results having transitions and effects can be previewed without being rendered, while Adobe Premier cannot automatically preview results.

The video editing method according to the present invention is designed to have an open architecture: a user has direct access to a decision list and can add/remove any resources. Also, a user can use user-defined transformation if its description is available in a certain format.

The method allows users to repeat the same action several times to achieve a desired result and even repeat just a certain operation that was done several steps before without repeating these steps.

Editing and previewing stages are combined, but rendering is separated and not necessary required. Rendering can be performed as the last stage of an editing process. Intervening results are stored as links, which means hypervideo editing. Hypervideo editing helps to optimize an encoding procedure, simultaneously use resources in different formats, save computer resources, e.g., a hard disk or memory, and efficiently manage the editing process.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A nonlinear video editing method comprising:
expressing a user action to be selected and performed as a template that includes a component, and described in an extended Markup Language (XML); and
performing the user action and rendering a result of the user action.

2. The method of claim 1, wherein the component comprises information on at least one of:
a name of the user action to be performed;
a number of input parameters used in the user action;
a number of output parameters output as results of the user action; and
a level of access to the user action.

3. A nonlinear video editing method comprising:
initializing a plurality of available user actions;
selecting one of the plurality of initialized available user actions;
selecting input resources that perform the selected available user action;
performing the selected available user action and examining results of the performed available user action; and
confirming finishing of the available user action and rendering the results of the finished user action.

4. The method of claim 3, wherein the user action includes information on at least one of:
a name of the user action to be performed;
a number of input parameters used in the user action;
a number of output parameters output as results of the user action; and
a level of access to the user action.

5. The method of claim 3, wherein the input resources include a transform that denotes transitions and effects that describe a user action to be performed, a physically existing real video clip, and a virtual union of the transform and the real video clip.

6. The method of claim 3, wherein, in the rendering step, the results include a list of performed user actions, logical results of user actions performed prior to the rendering step, and real video files.

7. The method of claim 3, wherein the available user actions include a resource importing action, a resource closing action, an editing result deleting action, an editing result exporting action, a clip splitting action, a clip merging action, and a clip inserting action.

8. The method of claim 7, wherein the resource importing action receives local files from an external source or data from a digital camera or an Internet streaming source, and edits the received files and data.

9. The method of claim 7, wherein the editing result exporting action stores the editing results in a unique data format designated by a user.

10. The method of claim 9, wherein the unique data format is MPEG-2.

11. A nonlinear video editing apparatus comprising:
a user action initialization unit that initializes available user actions;
a user action input unit that receives a user action selected by a user from the initialized available user actions;
a resource input unit that receives input resources used to perform the selected user action;
a user action performing unit that performs the selected user action based on the respective outputs of the user action initialization unit, the user action input unit and the resource input unit;
a result examining unit that examines results of the performed selected user action; and
a rendering unit that confirms finishing of the selected user action and renders the results of editing.

12. The apparatus of claim 11, wherein the user action includes at least one of information on:
a name of the user action to be performed;
a number of input parameters used in the user action;
a number of output parameters output as the results of the user action; and
a level of access to the user action.

13. A graphic user interfacing method in a nonlinear video editor, comprising:
presenting available user actions to a user and providing a display for receiving a user action selected by the user;
providing a source file display for presenting and displaying a source file used to perform the selected user action; and
providing a result display for displaying results of the selected user action performed using the source file selected by the user.

14. The method of claim 13, wherein each of the available user actions is expressed in a resource that represents input files used to perform the user action, a transform that denotes one of a transition and an effect used to describe the user action with respect to the resource, and a virtual union of the resource and the transform.

15. The method of claim 14, wherein the resource includes information on a time to start displaying the resource, a time to stop displaying the resource, a time to start editing the resource, a time to stop editing the resource, a name of a resource file, and whether sound is available.

16. The method of claim 14, wherein the virtual union includes information on a time to start editing the resource, a time to stop editing the resource, and whether sound is available.

17. A computer readable medium configured to implement instructions for nonlinear video editing method, said instructions comprising:
initializing a plurality of available user actions;
selecting one of the plurality of initialized available user actions;
selecting input resources that perform the selected available user action;
performing the selected available user action and examining results of the performed available user action; and
confirming finishing of the available user action and rendering the results of the finished user action.

18. The computer readable medium of claim 17, wherein the user action includes information on at least one of:
a name of the user action to be performed;
a number of input parameters used in the user action;
a number of output parameters output as results of the user action; and
a level of access to the user action.

19. The computer readable medium of claim 17, wherein the input resources include a transform that denotes transitions and effects that describe a user action to be performed, a physically existing real video clip, and a virtual union of the transform and the real video clip.

20. The computer readable medium of claim 17, wherein, in the rendering instruction, the results include a list of performed user actions, logical results of user actions performed prior to the rendering instruction, and real video files.

21. The computer readable medium of claim 17, wherein the available user actions include a resource importing action, a resource closing action, an editing result deleting action, an editing result exporting action, a clip splitting action, a clip merging action, and a clip inserting action.

22. The computer readable medium of claim 21, wherein the resource importing action receives local files from an external source or data from a digital camera or an Internet streaming source, and edits the received files and data.

23. The computer readable medium of claim 21, wherein the editing result exporting action stores the editing results in a unique data format designated by a user.

24. The computer readable medium of claim 23, wherein the unique data format is MPEG-2.
